(19) United States
(12) Patent Application Publication
(10) Pub. No.: US 2026/0109363 A1
(43) Pub. Date: Apr. 23, 2026

(54) SYSTEMS AND METHODS FOR HEALTH MONITORING AND INTERVENTION FOR VEHICLES

(71) Applicant: Via Fortuna, LLC, Wilmington, DE (US)

(72) Inventor: Satyan Chandra, Sunnyvale, CA (US)

(21) Appl. No.: 19/361,689

(22) Filed: Oct. 17, 2025

Related U.S. Application Data
(60) Provisional application No. 63/708,925, filed on Oct. 18, 2024.

(51) Int. Cl. B60W 50/029; B60W 30/182; B60W 50/00; B60W 50/04; B60W 50/14; G07C 5/08

(52) U.S. Cl. CPC B60W 50/029; B60W 30/182; B60W 50/045; B60W 50/14; G07C 5/08; B60W 2050/0095

(57) ABSTRACT

Disclosed embodiments may include systems and methods for health monitoring and proactive intervention for vehicles. The system may receive first input data associated with a first vehicle component while operating the vehicle in a first mode. Then, the system may determine, using a first machine learning model, a first threshold associated with the first vehicle component based on the first input data. Then, the system may receive second input data associated with the first vehicle component. The system may determine whether the first vehicle component is operating outside the first threshold based on the second input data and then operate the vehicle in a second mode that reduces degradation of the first vehicle component.

### CROSS-REFERENCE TO RELATED APPLICATIONS

This application claims priority, under 35 U.S.C. § 119(e), to U.S. Provisional Patent Application No. 63/708,925, filed Oct. 18, 2024, the entire contents of which is fully incorporated herein by reference.

### FIELD

The disclosed technology relates to systems and methods for health monitoring and intervention for vehicles. Specifically, this disclosed technology relates to using machine learning models to aid in proactively monitoring assorted vehicle components, determining whether they are operating outside an optimal range, and modifying operation of the components to increase lifespan or reduce degradation.

### BACKGROUND

Modern vehicles (e.g., electric vehicles, internal combustion engine vehicles) have hundreds of signals that relay critical information back and forth between different systems. These signals provide vital information on the health of assorted systems, such as the battery pack, motors, or thermal system. As the systems and components are used and age, they can fail completely or intermittently operate. Present vehicle systems typically warn the driver of the failing component based on the received signals (e.g., using a malfunction indication light or warning) and, at best, provide some rudimentary form of “loadshed” by reducing functionality of the problematic system or component. This gives the driver little to no warning in advance, and the driver then has to schedule service to replace the failing vehicle component.

Accordingly, there is a need for improved systems and methods for proactive health monitoring and intervention for vehicles. Embodiments of the present disclosure are directed to this and other considerations.

### SUMMARY

Disclosed embodiments may include a system for health monitoring and intervention for vehicles. The system may include one or more processors, and memory in communication with the one or more processors and storing instructions that, when executed by the one or more processors, are configured to cause the system to provide for vehicle health monitoring and intervention. The system may receive first input data associated with a first vehicle component, the first input data comprising one or more first values for indicating potential degradation of the first vehicle component. The system may also determine, using a first machine learning model, one or more optimal ranges for the first vehicle component based on the first input data. Furthermore, the system may receive second input data associated with the first vehicle component. Additionally, the system may determine whether the first vehicle component is operating outside a first optimal range of the one or more optimal ranges based on the second input data. In response to determining that the first vehicle component is operating outside the first optimal range, the system may change from a standard operating mode to a first alternate operating mode. The first alternate operating mode may be for reducing degradation of the first vehicle component by performing one or more first actions prior to a failure of the first vehicle component.

Disclosed embodiments may include a system for health monitoring and intervention for vehicles. The system may include one or more processors, and memory in communication with the one or more processors and storing instructions that, when executed by the one or more processors, are configured to cause the system to provide for health monitoring and intervention. The system may receive first input data associated with a first vehicle component. The system may also determine, using a first machine learning model, a first optimal range for the first vehicle component based on the first input data. Furthermore, the system may receive second input data associated with the first vehicle component. Additionally, the system may determine whether the first vehicle component is operating outside the first optimal range based on the second input data and without an observed loss of functionality. In response to determining the first vehicle component is operating outside the first optimal range based on the second input data, the system may modify one or more first operating parameters associated with the first vehicle component.

Disclosed embodiments may include a system for health monitoring and intervention for vehicles. The system may include one or more processors, and memory in communication with the one or more processors and storing instructions that, when executed by the one or more processors, are configured to cause the system to provide for health monitoring and intervention. The system may receive first input data associated with a first vehicle component while operating the vehicle in a first mode. Additionally, the system may determine, using a first machine learning model, a first threshold associated with the first vehicle component based on the first input data. The system may also receive second input data associated with the first vehicle component. Furthermore, the system may determine whether the first vehicle component is operating outside the first threshold based on the second input data. In response to determining that the first vehicle component is operating outside the first threshold, the system may operate the vehicle in a second mode. The second mode may reduce degradation of the first vehicle component.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for health monitoring and intervention for vehicles in accordance with certain embodiments of the disclosed technology.

FIG. 2 is a flow diagram illustrating an exemplary method for health monitoring and intervention for vehicles in accordance with certain embodiments of the disclosed technology.

FIG. 3 is a block diagram of an example health monitoring and intervention system used to provide health monitoring and intervention for vehicles, according to an example implementation of the disclosed technology.

FIG. 4 is a block diagram of an example system that may be used for calibration and training systems to aid in providing health monitoring and intervention for vehicles, according to an example implementation of the disclosed technology.

FIG. 5 is a block diagram of an example system that may be used to provide health monitoring and intervention for vehicles, according to an example implementation of the disclosed technology.

FIG. 6 is a block diagram illustrating an example propulsion system that may be used with an example implementation of the disclosed technology.

FIG. 7A is a graph of an oil pump flow rate at a first intervention level according to an example implementation of the disclosed technology.

FIG. 7B is a graph of an oil pump flow rate at a second intervention level according to an example implementation of the disclosed technology.

FIG. 7C is a graph of torque of an electric motor in a normal operating mode according to an example implementation of the disclosed technology.

FIG. 7D is a graph of torque of an electric motor at a third intervention level according to an example implementation of the disclosed technology.

FIG. 7E is a graph of an oil pump flow rate at first, second, and third intervention levels according to an example implementation of the disclosed technology.

FIG. 8A is a block diagram illustrating an example pneumatic system that may be used with an example implementation of the disclosed technology.

FIG. 8B is a block diagram illustrating the coolant subsystem of an example pneumatic system that may be used with an example implementation of the disclosed technology.

FIG. 9A is a graph of the increased output of one or more coolant pumps at three intervention sublevels according to an example implementation of the disclosed technology.

FIG. 9B is a graph of motor shaft RPM and output mass flow rate at a third intervention level according to an example implementation of the disclosed technology.

FIG. 9C is a graph of motor RPM over time at a fifth intervention level according to an example implementation of the disclosed technology.

### DETAILED DESCRIPTION

Disclosed embodiments may include the dynamic and live monitoring of system parameters of different vehicle components continuously over time. From the live monitoring, the system may include determining and saving critical parameters indicative of predicting vehicle component health, and establishing trend behaviors to determine whether or not an imminent failure or performance reduction in a specific component expected. If a failure is expected, the system may instruct the vehicle to take mitigatory steps to repair, or mitigate the effect of, the degrading trend of the component. This maximizes the operational life of individual vehicle components (as well as the vehicle) and prevents catastrophic loss of function. The system may be capable of instructing and monitoring other systems such that basic troubleshooting strategies may be implemented to correct the problem during normal vehicle operation, allowing the vehicle to avoid unnecessary service visits. This may also allow the vehicle to continue to operate for substantially longer periods of time before service is required.

Accordingly, the disclosed embodiments rely on ingesting data from hundreds of different vehicle systems to determine signs of future vehicle component failure. Accordingly, as the vehicle ages and deteriorates, received data from components may begin to show nascent signs of compromised functionality, such as increased current draw, far before the component intermittently fails. Therefore, the present system determines, based on comparing current data with past data, and other data (e.g., expected data or data common other vehicles with similar components), indicators that are signs of future component failure. By determining that a component is operating outside an optimal range at an early stage, the system may be able to intervene to (1) extend the life of the component by changing its operation or operation of other related components, (2) prevent the component from failing by changing its operation or operation of other related components, (3) avoid observable functionality loss to the user, and (4) notify the user that a component is operating outside a normal range substantially before the component fails. Overall, the system may use data monitoring from various devices to make determinations regarding long-term trends and transmit remedial instructions or strategies to devices or systems to prolong component life and avoid premature failure.

Examples of the present disclosure related to systems and methods for health monitoring and intervention for vehicles. More particularly, the disclosed technology relates to determining proactive indicators of vehicle system health, establishing an optimal range for system health, determining whether a vehicle component is operating within the optimal range, and, if not, modifying the operation of the vehicle component or associated system to prevent further degradation of the vehicle component. The systems and methods described herein utilize, in some instances, machine learning models, which are necessarily rooted in computers and technology. Machine learning models are a unique computer technology that involves training models to complete tasks and make decisions. Using a machine learning model in this way may allow the system to determine vehicle signals indicative of future component degradation, and proactively mitigate component failure by changing component operation in advance. This is an advantage and improvement over prior technologies that because prior technologies cannot actively mitigate (and potentially prevent) component failures before they occur, and rather just alert a user of a failure once it has already occurred. The present disclosure solves this problem by using machine learning models to identify an optimal range for component operation, and identify when components are operating outside the optimal range. Overall, the systems and methods disclosed have significant practical applications in the vehicle health detection and vehicle servicing fields because of the noteworthy improvements of using machine learning models to detect and mitigate potential future component failures, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

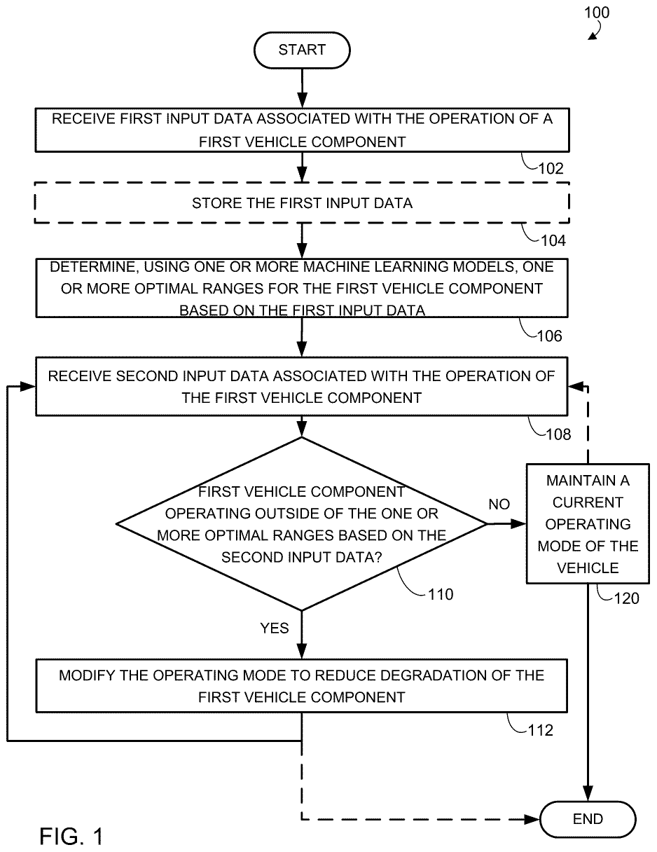

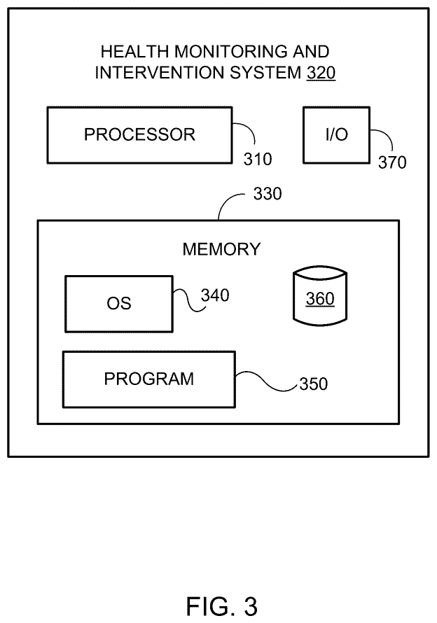

FIG. 1 is a flow diagram illustrating an exemplary method 100 for health monitoring and intervention for vehicles, in accordance with certain embodiments of the disclosed technology. The steps of method 100 may be performed by one or more components of the system 500 (e.g., health monitoring and intervention system 320, as described in more detail with respect to FIGS. 3-5. Method 100 may be continuously repeated and iterated as the vehicle operates. Method 100 may be used with multiple types of vehicles include electric vehicles (EVs), plug-in hybrid vehicles (PHEV), and internal combustion engine (ICE) vehicles.

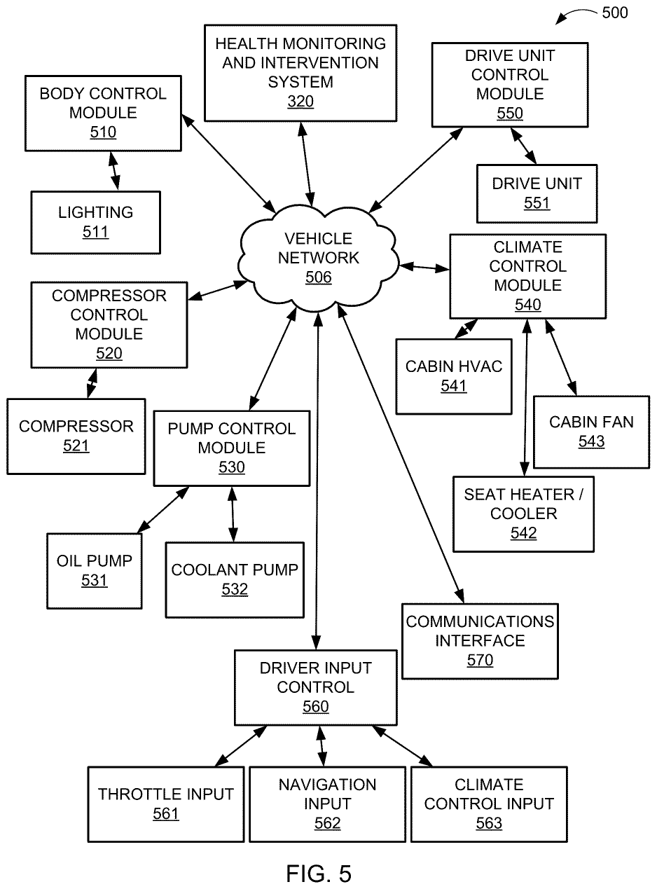

In block 102, the health monitoring and intervention system 320 may receive first input data. The first input data may be associated with the operation of a first vehicle component. The first input data may be data regarding a vehicle components or systems over a duration (e.g., a medium or long period of time) and may be a result of monitoring vehicle components or systems. The first input data may include continuous and live data from numerous vehicle components and vehicle systems. This may be received via modules located within the vehicle (e.g., from body control module 510, compressor control module 520, pump control module 530, climate control module 540, drive unit control module 550, driver input control 560, and communications interface 570 of FIG. 5. For example, the driver input control 560 (FIG. 5) may receive average throttle input data (as received from throttle input 561 of FIG. 5) which may be transmitted to health monitoring and intervention system 320 over the vehicle network 506 (FIG. 5). In another example, the climate control module 540 (FIG. 5) may transmit power consumption data to the health monitoring and intervention system 320 via the vehicle network 506 (FIG. 5). Input data may include a present power consumption of the component (e.g., the power consumption in watt-hours or kilowatt-hours), a temperature of the component (e.g., battery temperature or drive unit temperature), a pressure indication of the component (e.g., oil pressure or fuel pressure), circuit resistance (e.g., a circuit rating in ohms), and voltage output. First input data may be standardized, normalized, or aggregated. First input data may be data may be averaged over a specific period to adjust for individual outliers or irregularities in the data. First input data may include data representative of operation of the first vehicle component over a period of time (e.g., a day, a week, a month, 3 months, 6 months, 1 year).

First input data may be received on a regularly scheduled basis from other modules (which may broadcast the data over vehicle network 506). In other embodiments, the health monitoring and intervention system 320 may poll other vehicle modules for input data. In some embodiments, first input data may include training data (e.g., data transmitted from calibration system 408 to enhance health monitoring and intervention system 320), crowdsourced data (e.g., average data from other vehicles with other similar components transmitted from calibration system 408 to enhance health monitoring and intervention system 320), and manufacturer data (e.g., standards data, as described with reference to block 104).

The first vehicle component may be a variety of different vehicle components. The health monitoring and intervention system 320 may be capable of monitoring and intervening with the operations of multiple vehicle components at one time. Vehicle components that the health monitoring and intervention system 320 may interact with may include: drive units, drive batteries, 12V batteries, engines, pumps (e.g., oil pumps, coolant pumps), radiators (e.g., primary radiator, auxiliary radiator, heater core, intercooler), thermostats, vehicle compressors, air conditioning compressors, cooling fans, air conditioning fans, blower motors, lights (e.g., interior lights, puddle lights, driving lights, high-beams, auxiliary lights, turn signal lights), electronic control modules (e.g., body control modules, engine control modules, transmission control modules, drive unit controllers, and battery controllers), fuse boxes, power supplies, differentials, differential locks (e.g., mechanical or electrical), suspension components (e.g., shocks, anti-roll bars, air springs, air spring compressor), switches (e.g., buttons, shifters, stalks, ignition interlocks), sensors (e.g., temperature sensors, pressure sensors, level sensors, proximity sensors, location sensors, level sensors, gyroscopic sensors, altimeters), solenoids (e.g., reverse lockout, neutral safety lockout), vacuum pumps (e.g., electronic brake control, smog pumps), power steering racks (e.g., electric power steering racks), door locks (e.g., electric door locks, truck locks, front storage or hood locks), door handles (e.g., electric door handles), windows (e.g., electronic window apparatuses including electronic window motors), seats (e.g., electronic seat control motors), safety systems (e.g., airbags and seatbelts), cameras (e.g., back-up camera), and displays (e.g., infotainment displays, instrument cluster displays, dash displays, rear seat displays, heads-up displays). The health monitoring and intervention system 320 may interact with the above components (or associated control modules) to monitor signals including: potential difference (e.g., voltage), current (e.g., amperage), resistance (e.g., ohms), power (e.g., watts), energy (e.g., watt-hour), time (e.g., seconds), location (e.g., coordinates), temperature (e.g., degrees Celsius), distance (e.g., meters, miles), speed (e.g., meters per second, miles per hour, revolutions per minute, cycles per second), acceleration, audio data (e.g., sounds of vehicle components recorded by a microphone), video data, and waveforms (e.g., inputs from variable reluctance or hall effect sensors).

In optional block 104, the health monitoring and intervention system 320 may store some or all of the first input data. The first input data may be stored as historical data. The first input data received may be stored for a predetermined amount of time (e.g., 1 day, 15 days, 30 days, or 90 days). The amount of time the first input data is stored may vary on the type of input data (e.g., drive unit current may be more useful to store for longer periods than outside air temperature). In some embodiments, the health monitoring and intervention system 320 may also store standards data, which may be characterized as data specifications for components as determined by the vehicle manufacturer. For example, standards data may include that a powertrain compressor may have a power consumption operating envelope of 500 W to 12 kW. Standards data may be stored by the health monitoring and intervention system 320 indefinitely.

In block 106, the health monitoring and intervention system 320 may determine one or more optimal ranges for a first vehicle component based on the first input data. The health monitoring and intervention system 320 may use one or more machine learning models to determine the one or more optimal ranges and/or one or more optimal thresholds. The one or more machine learning models used by health monitoring and intervention system 320 at block 106 may use the first input data received to generate one or more optimal ranges or optimal thresholds for the first vehicle component. The one or more machine learning models may also use training data which may be provided as part of the first input data or may be provided as separate data. The one or more machine learning models may be used by health monitoring and intervention system 320 to predict which data and what values of the first input data is indicative of future problems of the first vehicle component. For example, by receiving first input data over the past three months that the powertrain compressor on this vehicle has a power consumption operating envelope between 480 W and 11.75 kW, the one or more machine learning models may generate that the optimal range for this powertrain compressor is 470 W to 11.9 kW.

The optimal range may also be influenced by the standards data associated with the component provided by the manufacturer (500 W to 12 kW, as described with reference to block 104). However, the health monitoring and intervention system 320 may adjust optimal range from the standards data (e.g., the optimal range may be different from the standards data) to accommodate for operating differences between different components (e.g., as shown above the optimal range for the powertrain compressor of 470 W to 11.9 kW is different from the standards data of 500 W to 12 kW). The standards data provided by a manufacturer may be overly broad to capture a variety of operating conditions and accommodate the operation of the entire production of a vehicle component. The standards data may provide values that indicate errors in components (e.g., a malfunction indication). The present health monitoring and intervention system 320 may utilize the standards data to aid in forming an optimal range or optimal threshold, but standards data may not be dispositive in forming an optimal range or optimal threshold. The optimal ranges and thresholds of health monitoring and intervention system 320 may generally be more specific and/or narrower than standards data.

The health monitoring and intervention system 320 may use trend analysis to determine the one or more optimal ranges or one or more thresholds. For example, if coolant fan current is determined to be 10 A at 80% power from first input data received in May, then in June, the current at 80% power is 10.2 A, and then in July, the current at 80% power 10.6 A, the health monitoring and intervention system 320 may use trend analysis to determine or extrapolate an appropriate optimal range or threshold (e.g., that current is increasing at an above-expected rate, and setting a current threshold at 80% power at 10.8 A). Furthermore, the health monitoring and intervention system 320 may utilize several data points when making a determination of an optimal range or threshold (e.g., in the above example, the current is increase at an above-expected rate, but the outdoor air temperature received during July is hotter than May in the locations the vehicle is primarily driven, and hotter temperatures may lead to increased current, therefore setting the threshold for 80% power at 11 A).

The one or more optimal ranges or one or more optimal thresholds may be static (e.g., fixed) or dynamic (e.g., regularly and iteratively changing). The health monitoring and intervention system 320 may be configured to run on a set schedule (e.g., once per day) and update optimal ranges and thresholds. The health monitoring and intervention system 320 may be configured to continuously run as new input data is acquired and constantly adjust the one or more optimal ranges and thresholds to accommodate for trends in how vehicle components operate.

In some embodiments, the health monitoring and intervention system 320 may generate a series of optimal ranges and/or optimal thresholds. For example, a first range or threshold may indicate an ideal operating condition, where no action is necessary to prevent degradation. A second range or threshold may indicate a potentially degrading operating condition, where the health monitoring and intervention system may monitor the input data of the component more frequently. A third range or threshold may indicate a degrading operating condition requiring intervention. In some embodiments, a first range or threshold may indicate a degrading operating condition requiring intervention, and a second range or threshold may indicate that the degrading operating condition is beyond the intervening capabilities of the health monitoring and intervention system 320. In some embodiments, the optimal ranges or thresholds generated by the health monitoring and intervention system 320 may include alternative guidance strategies such as limits, logical operators, and/or Boolean operators that require multiple inputs.

In some embodiments, the health monitoring and intervention system 320 may transmit the one or more optimal ranges and thresholds to individual modules of the vehicle.

In block 108, the health monitoring and intervention system 320 may receive second input data associated with the first vehicle component. The second input data may be current input data. The second input data may be live data associated with the first vehicle component (e.g., a current, voltage, flow rate, speed). The second input data may be more specific or a subset of the first vehicle data. The first vehicle data may be a large amount of data regarding every vehicle system that may be received or polled on a less frequent basis, but second vehicle data may be a subset of data determined to be significant to indicating component health that may be polled or received on a more frequent basis. If specific data is determined in block 106 by health monitoring and intervention system 320 to be useful for indicating the health of a component, the health monitoring system 320 may poll the individual module or system to receive the data on a more frequent basis. Receiving the second input data may be generally similar to receiving the first input data described with respect to block 102. Accordingly, block 108 may be otherwise similar in its respective description to block 102 and is not repeated herein for brevity. The health monitoring and intervention system 320 may store the data received in block 108 similar to as described with respect to block 104.

In block 110, the health monitoring and intervention system 320 may determine whether the first vehicle component is operating outside the one or more optimal ranges. The health monitoring and intervention system 320 may use the second input data for determining whether the first vehicle component is operating outside the one or more optimal ranges. For example, if optimal range for the powertrain compressor is 470 W to 11.9 kW, as determined in block 106, and the health monitoring and intervention system 320 receives second input data indicating that the powertrain compressor is operating at 12.5 kW, then the health monitoring and intervention system 320 may determine that the powertrain compressor is operating outside the optimal range because the received second input data is greater than the upper limit of the range. Similarly, if the health monitoring and intervention system 320 receives second input data indicating that the powertrain compressor is operating at 200 W, then the health monitoring and intervention system 320 may determine that the powertrain compressor is operating outside the optimal range because the received second input data is less than the upper limit of the range. The health monitoring and intervention system 320 may use similar determinations with thresholds. For example, if the upper threshold for current for the cooling fan is 10 A, and the health monitoring and intervention system 320 receives second input data indicating that the current is 12 A, then the health monitoring and intervention system 320 may determination that the cooling fan is operating outside the one or more optimal ranges because the current is greater than the upper threshold.

If health monitoring and intervention system 320 determines that a specific vehicle component is outside an optimal range, then input data may be received, polled, or retrieved by health monitoring and intervention system 320 (e.g., at block 108) on a more frequent basis. In some embodiments, the health monitoring and intervention system 320 may dynamically determine to store some data for longer amounts of time than other data. For example, if health monitoring and intervention system 320 determines that input data regarding a first vehicle component is inside an optimal range, then input data may be stored for less time (e.g., at block 108) than input data regarding a second vehicle component determined to be outside an optimal range. This allows health monitoring and intervention system 320 to save storage space.

If the health monitoring and intervention system 320 determines that the first vehicle component is operating outside an optimal range, method 100 may continue to block 112. If the health monitoring and intervention system 320 determines that first vehicle component is operating within an optimal range, method 100 may continue to block 120.

In block 112, as a result of determining the first vehicle component is operating outside an optimal range, the health monitoring and intervention system 320 may modify an operating mode associated with the first vehicle component. The modified operating mode may be configured to reduce degradation of the first vehicle component. The modified operating mode may directly affect the operation of the first vehicle component (e.g., if the first vehicle component is a cooling fan, then the modified operating mode may adjust the speed of the cooling fan). Alternatively or additionally, the modified operating mode may affect the operation of other components or system related to the first vehicle component (e.g., if the first vehicle component is a water-cooled compressor, the modified operating mode may change the operation the coolant pump that pumps coolant to the compressor to increase flow to cool down the compressor). In some embodiments, the modified operating mode may include instructions that modify the operation of several components (e.g., if the first vehicle component is a cooling fan, the modified operating mode may include adjusting the maximum speed of the cooling fan to be limited to 90%, increasing the flow of a coolant pump to compensate for the maximum speed of the cooling fan being 90%, and increasing the typical speed of a second coolant fan by +10% over the speeds in a standard operating mode). Examples of modifications to the operating mode of a component may include: lowering power output (e.g., from a standard operating mode amount, such as a standard operating value less 10%), running a temporary program (e.g., a blockage reduction cycle or bleeding cycle on a coolant pump), altering a start-up and shut-down routine (e.g., to generate less heat or cause less of an electrical load, but be slightly slower in performance), lower temperatures (e.g., by increasing coolant flow from a coolant pump or electric fan), and increasing lubrication (e.g., by increasing oil flow).

The modified operating mode may be intended to be unnoticeable to the user (e.g., the driver), and seamless (e.g., so that the user does not notice any difference in performance in the vehicle between a standard operating mode and the modified operating mode). By modifying the operating mode of the component, the health monitoring and intervention system 320 may preemptively repair components by adjusting the load on a component or adjusting how a component operates. This allows vehicle components to last longer, and may ultimately prevent the need for repair or replacement of components, saving the driver time (e.g., having to drive the vehicle to a shop for service and losing the use of the vehicle) and the manufacturer money (e.g., having to repair parts that may be under warranty). Furthermore, by preemptively preventing a component from failing completely, it may prevent more damaging failures (e.g., a minor short in a powertrain compressor may be prevented from progressively becoming worse to the point of damaging a main battery pack). Additionally, by optimizing vehicle components to run at optimal performance levels specific to each component, the health monitoring and intervention system 320 may also enhance the performance and efficiency of each component.

In some embodiments, the modification of the operating mode may be controlled by predetermined tables (e.g., tabular values indicate how to change the operation of a component if certain indications are detected). In some embodiments, the modification of the operation mode may be controlled by one or more machine learning models. The one or more machine learning models may have similar features to the machine learning models described with reference to block 106 or be different from the machine learning models as described with reference to block 106. The one or more machine learning models may be trained to manipulate or adjust the values the values of a standard operating mode to create a modified operating mode for a component to prevent degradation.

After modifying the operating mode to reduce degradation of the first vehicle component in block 112, the method 100 may return to block 108 to iteratively receive new input data. Blocks 108 and 110 may then be repeated to determine if the modification of the operating mode has reduced the degradation by allowing the first vehicle component to operate within the one or more optimal ranges. Health monitoring and intervention system 320 may iterate different modifications of the operating mode repeatedly (e.g., by repeating blocks 108, 110, and 112) until finding a solution that allows the first vehicle component to operate within the one or more optimal ranges. If the health monitoring and intervention system 320 modifies the operating mode above a predetermined threshold number of times to attempt to prevent degradation of the first vehicle component, the health monitoring and intervention system 320 may transmit a message to the driver through the infotainment screen notifying the user that the first vehicle component is operating normally, but may require service in the future. If the health monitoring and intervention 320 is unable to modify the operating mode so that the first vehicle components operates within the one or more optimal ranges, the health monitoring and intervention system 320 may transmit a message to the driver through the infotainment screen notifying the user that the first vehicle component is operating normally, but outside an optimal range, and may require service in the future. In some embodiments, after making a modification to the operating mode, the method 100 may end.

In block 120, as a result of determining the first vehicle component is operating within an optimal range, the health monitoring and intervention system 320 may maintain the current operating mode of the vehicle. The first current operating mode (e.g., a primary operating mode) may be a standard operating mode (e.g., an operating mode used from when the vehicle is new and may be characterized by features and components operating at a fully functional and/or optimal level). As a result, the method 100 may end. In some embodiments, after block 120, the method 100 may return to block 108 (as shown via the dashed arrow in FIG. 1). The method 100 may return to block 108 on a schedule, as a result of a triggering action, or iteratively. In some embodiments, the health monitoring and intervention system 320 may constantly and iteratively receive additional (or new) second input data (or third input data, fourth input data, etc.) and the system may repeat steps 108 and 110 to determine if the additional or second input data indicates that the first vehicle component is outside the one or more optimal ranges and/or thresholds. The health monitoring and intervention system 320 may repeat blocks 112 and 120 as necessary (as determined by block 110) in order to keep the first vehicle component running optimally.

In multiple iterations of blocks 108, 110, 112, and 120, the operating mode of the first vehicle component may change multiple times. For example, during a first iteration with the second input data, the first vehicle component may be within the one or more optimal ranges, and the health monitoring and intervention system 320 may maintain the current operating mode (e.g., via block 120). During a second iteration with third input data, the first vehicle component may be detected to be outside the one or more optimal ranges (at block 110), and the health monitoring and intervention system 320 may modify the operating mode to reduce degradation to be a first modified operating mode (at block 112). During a third iteration with fourth input data, received after a waiting period, the health monitoring and intervention system 320 may determine that the first vehicle component is within the one or more optimal ranges (at block 110) and that the current operating mode (e.g., the first modified operating mode from the second iteration) should be maintained (at block 120).

In some embodiments, in the multiple iterations, multiple ranges may be used. Using the above example, after some time, a 45^{th} iteration occurs, receiving 46^{th} input data where the first vehicle component is outside a second optimal range different from the first optimal range (at block 110). The health monitoring and intervention system 320 proceeds to block 112 to further modify the current operating mode (e.g., the first modified operating mode from the second iteration). The vehicle then operates with a second modified operating mode.

In some embodiments, the health monitoring and intervention system 320 may iteratively rerun blocks 102 through 106 to verify that the one or more optimal ranges are still valid. This may incorporate new input data (e.g., the second input data). In some embodiments, health monitoring and intervention system 320 may perform blocks 102 through 106 and transmit the one or more optimal ranges to individual modules. The individual modules may then perform blocks 108 through 102 and transmit data regarding the second input data and operating mode to health monitoring and intervention system 320.

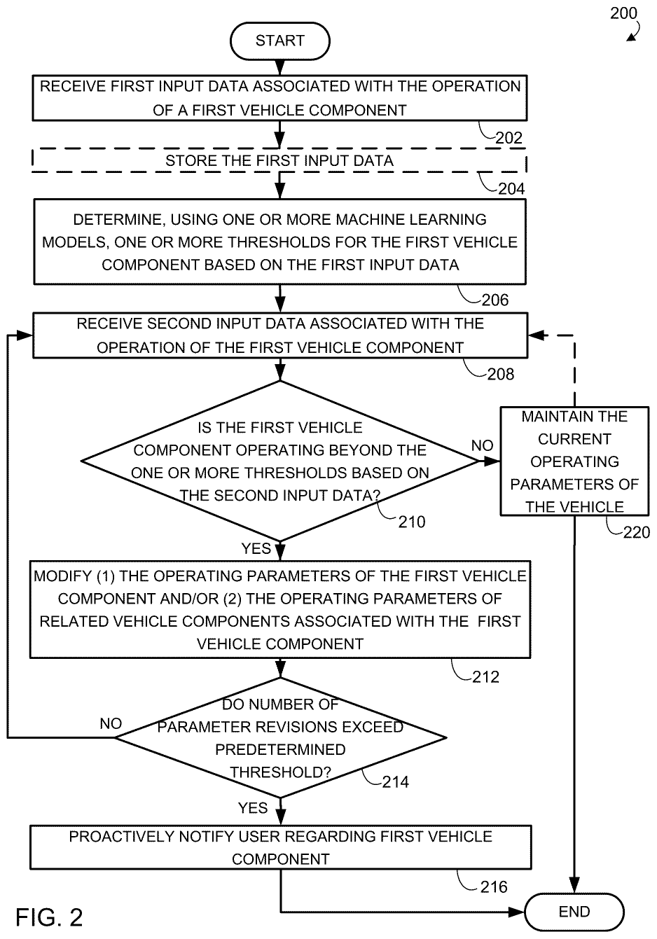

FIG. 2 is a flow diagram illustrating an exemplary method 200 for health monitoring and intervention for vehicles, in accordance with certain embodiments of the disclosed technology. The steps of method 200 may be performed by one or more components of the system 500 (e.g., health monitoring and intervention system 320), as described in more detail with respect to FIGS. 3-5.

Method 200 of FIG. 2 is similar to method 100 of FIG. 1, except that method 200 may not include blocks 108 or 114 of method 100. The descriptions of blocks 202, 204, 206, 208, and 210 in method 200 are similar to the respective descriptions of blocks 102, 104, 106, 108, and 110 of method 100 and are not repeated herein for brevity. However, blocks 212 and 220 are different from blocks 112 and 120 and are described below. Additional blocks 214 and 216 are further described below. Method 200 may be continuously repeated and iterated as the vehicle operates. Method 200 may be used with multiple types of vehicles include electric vehicles (EVs), plug-in hybrid vehicles (PHEV), and internal combustion engine (ICE) vehicles.

Block 212 may describe different actions that health monitoring and intervention system 320 may, in various embodiments, take depending on the specific vehicle component implicated and/or the specific value or range that is received from the input data.

In block 212, the health monitoring and intervention system 320 may modify the operating parameters associated with the first vehicle component. Operating parameters may be instructions that the vehicle uses to control components and/or systems of the vehicle (e.g., digital messages transmitted over a vehicle network such as can-bus or ethernet). The operating parameters associated with the first vehicle component may be operating parameters directly associated with the operation of the first vehicle component or operating parameters regarding operations of systems that affect or are related to the first vehicle component. For example, if the first vehicle component is an oil pump with an auxiliary cooling fan, the health monitoring and intervention system 320 may directly alter operating parameters of the oil pump by limiting the pump's maximum output to 90% instead of the full 100%. Alternatively or additionally, the health monitoring and intervention system 320 may alter operating parameters of components related to the oil pump. Accordingly, the health monitoring and intervention system 320 may increase the duty cycle of the fan cooling the oil pump to lower the temperature of the oil pump (e.g., from a normal duty cycle of 50% to an elevated duty cycle of 60%). In some embodiments, the health monitoring and intervention system 320 may modify more than one set of operating parameters associated with the first vehicle component. Accordingly, block 212 may be otherwise similar in its respective description to block 112 and is not repeated herein for brevity.

In block 214, the health monitoring and intervention system 320 may determine whether the number of parameter revisions exceed a predetermined threshold. In some embodiments, the health monitoring and intervention system 320 may monitor the number of times the operating parameters are changed in order for a component to maintain the one or more optimal ranges or optimal thresholds. If a component has an excessive number of parameter revisions, it may indicate a future problem with the component and/or system that may require service in the future. The predetermined threshold of parameter revisions may be specific to a type of vehicle component or vehicle system (e.g., if a system is critical or non-critical), and may also be related to the number of revisions of the one or more optimal ranges or optimal thresholds. If the parameter revisions exceed the predetermined threshold, the method 200 may proceed to block 216. If the parameter revisions do not exceed the predetermined threshold, the method 200 may return to block 208 to receive second input data (or additional input data).

In block 216, the health monitoring and intervention system 320 may proactively notify the user (e.g., the driver) regarding the first vehicle component. If the parameter revisions exceed the predetermined threshold, the health monitoring and intervention system 320 may transmit a notification to the user (e.g., via the infotainment system) indicating the first vehicle component is operating normally, but may require service in the future. The notification may occur substantially before any functionality of the vehicle is lost. In some embodiments, after block 216, the method 200 may end. In some embodiments, after block 216, the method 200 may return to block 208 to continue to receive data and modify the operating parameters if necessary (

In block 220, the health monitoring and intervention system 320 may maintain the current operating parameters of the vehicle. The first current operating parameters may be operating parameters that are used by the vehicle when in a peak condition (and no degradation has occurred). The current operating parameters may change as operating parameters are changed to prevent degradation in block 212. Accordingly, block 220 may be otherwise similar in its respective description to block 120 and is not repeated herein for brevity.

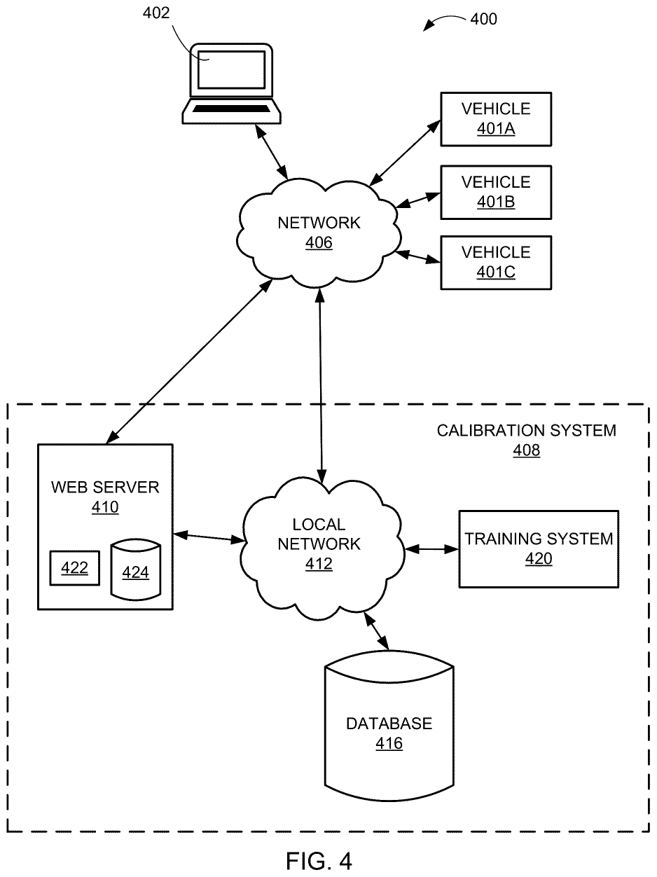

FIG. 3 is a block diagram of an example health monitoring and intervention system 320 used to determine whether one or more vehicle components are operating in optimal ranges and modify the operation of the vehicle components if necessary according to an example implementation of the disclosed technology. According to some embodiments, the user device 402, training system 420, and web server 410, as depicted in FIG. 4, and the body control module 510, compressor control module 520, pump control module 530, climate control module 540, drive unit control module 550, driver input control 560, and communications interface 570, as depicted in FIG. 5 and described below, may have a similar structure and components that are similar to those described with respect to health monitoring and intervention system 320 shown in FIG. 3. As shown, the health monitoring and intervention system 320 may include a processor 310, an input/output (I/O) device 370, a memory 330 containing an operating system (OS) 340 and a program 350. In certain example implementations, the health monitoring and intervention system 320 may be a single server or may be configured as a distributed computer system including multiple servers or computers that interoperate to perform one or more of the processes and functionalities associated with the disclosed embodiments. In some embodiments health monitoring and intervention system 320 may be one or more servers from a serverless or scaling server system. In some embodiments, the health monitoring and intervention system 320 may further include a peripheral interface, a transceiver, a mobile network interface in communication with the processor 310, a bus configured to facilitate communication between the various components of the health monitoring and intervention system 320, and a power source configured to power one or more components of the health monitoring and intervention system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the health monitoring and intervention system 320 may include one or more storage devices configured to store information used by the processor 310 (or other components) to perform certain functions related to the disclosed embodiments. In one example, the health monitoring and intervention system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The health monitoring and intervention system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the health monitoring and intervention system 320 may include the memory 330 that may include one or more programs 350 to perform one or more functions of the disclosed embodiments. For example, in some embodiments, the health monitoring and intervention system 320 may additionally manage dialogue and/or other interactions with the customer via a program 350.

The processor 310 may execute one or more programs 350 located remotely from the health monitoring and intervention system 320. For example, the health monitoring and intervention system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a health monitoring and intervention system database 360 for storing related data to enable the health monitoring and intervention system 320 to perform one or more of the processes and functionalities associated with the disclosed embodiments.

The health monitoring and intervention system database 360 may include stored data relating to status data (e.g., average session duration data, location data, idle time between sessions, and/or average idle time between sessions) and historical status data. According to some embodiments, the functions provided by the health monitoring and intervention system database 360 may also be provided by a database that is external to the health monitoring and intervention system 320, such as the database 416 as shown in FIG. 4 or in other vehicle modules shown in FIG. 5.

The health monitoring and intervention system 320 may also be communicatively connected to one or more memory devices (e.g., databases) locally or through a network. The remote memory devices may be configured to store information and may be accessed and/or managed by the health monitoring and intervention system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The health monitoring and intervention system 320 may also include one or more I/O devices 370 that may comprise one or more interfaces for receiving signals or input from devices and providing signals or output to one or more devices that allow data to be received and/or transmitted by the health monitoring and intervention system 320. For example, the health monitoring and intervention system 320 may include interface components, which may provide interfaces to one or more input devices, such as one or more keyboards, mouse devices, touch screens, track pads, trackballs, scroll wheels, digital cameras, microphones, sensors, and the like, that enable the health monitoring and intervention system 320 to receive data from a user (such as, for example, via the user device 402).

In examples of the disclosed technology, the health monitoring and intervention system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The health monitoring and intervention system 320 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The health monitoring and intervention system 320 may be configured to adjust model parameters during training. Model parameters may include weights, coefficients, offsets, or the like. Training may be supervised or unsupervised.

The health monitoring and intervention system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The health monitoring and intervention system 320 may be configured to optimize statistical models using known optimization techniques.

Furthermore, the health monitoring and intervention system 320 may include programs configured to retrieve, store, and/or analyze properties of data models and datasets. For example, health monitoring and intervention system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The health monitoring and intervention system 320 may include algorithms to determine a data type, key-value pairs, row-column data structure, statistical distributions of information such as keys or values, or other property of a data schema may be configured to return a statistical profile of a dataset (e.g., using a data-profiling model). The health monitoring and intervention system 320 may be configured to implement univariate and multivariate statistical methods. The health monitoring and intervention system 320 may include a regression model, a Bayesian model, a statistical model, a linear discriminant analysis model, or other classification model configured to determine one or more descriptive metrics of a dataset. For example, health monitoring and intervention system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The health monitoring and intervention system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, health monitoring and intervention system 320 may be configured to generate a similarity metric representing a measure of similarity between data in a dataset. A similarity metric may be based on a correlation, covariance matrix, a variance, a frequency of overlapping values, or other measure of statistical similarity.

The health monitoring and intervention system 320 may be configured to generate a similarity metric based on data model output, including data model output representing a property of the data model. For example, health monitoring and intervention system 320 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The health monitoring and intervention system 320 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The health monitoring and intervention system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, health monitoring and intervention system 320 is configured to generate and/or train a classification model to classify a dataset, consistent with disclosed embodiments.

The health monitoring and intervention system 320 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the health monitoring and intervention system may analyze information applying machine-learning methods.

While the health monitoring and intervention system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the health monitoring and intervention system 320 may include a greater or lesser number of components than those illustrated.

FIG. 4 is a block diagram of an example system that may be used to calibrate and train health monitoring and intervention system 320. Calibration system 408, according to an example implementation of the disclosed technology, may interact with different vehicles in order to provide data and/or aid in the training of health monitoring and intervention system 320. The components and arrangements shown in FIG. 4 are not intended to limit the disclosed embodiments as the components used to implement the disclosed processes and features may vary. As shown, calibration system 408 may interact with one or more vehicles 401a, 401b, 401c, and a user device 402 via a network 406. In certain example implementations, the calibration system 408 may include a local network 412, a training system 420, a web server 410, and a database 416.

In some embodiments, calibration system 408 may receive and transmit data to one or more vehicles 401a, 401b, 401c via network 406. The one or more vehicles 401a, 401b, 401c may each include a health monitoring and intervention system 320 on each vehicle. Each vehicle 401a, 401b, 401c may interact with calibration system 408 in order to train or refine health monitoring and intervention system 320. The calibration system 408 may be used to crowdsource data from multiple vehicles and use the crowdsourced data to enhance the energy efficiency of all the vehicles 401a, 401b, 401c by updating health monitoring and intervention system 320 or via training one or more machine learning models within health monitoring and intervention system 320.

In some embodiments, a user may operate the user device 402, which may be used to control calibration system 408. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the calibration system 408. In some embodiments, the user device 402 may include or incorporate electronic communication devices for hearing or vision impaired users.

Users of user device 402 may be employees of an entity in charge of configuring the training of the vehicle fleet. Users may also include individuals such as, for example, subscribers, clients, prospective clients, or customers of an entity associated with an organization, such as individuals who have obtained, will obtain, or may obtain a product, service, or consultation from or conduct a transaction in relation to an entity associated with the calibration system 408. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors. In some embodiments, users may also refer to drivers or passengers of vehicles, such as vehicles 401a, 401b, 401c.

The health monitoring and intervention system 320 may include programs (scripts, functions, algorithms) to configure data for visualizations and provide visualizations of datasets and data models on the user device 402. This may include programs to generate graphs and display graphs. The health monitoring and intervention system 320 may include programs to generate histograms, scatter plots, time series, or the like on the user device 402. The health monitoring and intervention system 320 may also be configured to display properties of data models and data model training results including, for example, architecture, loss functions, cross entropy, activation function values, embedding layer structure and/or outputs, convolution results, node outputs, or the like on the user device 402.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. The network 406 may be a cellular network, such as 3G, 4G LTE, or 5G. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The calibration system 408 may be associated with and optionally controlled by one or more entities such as a business, corporation, individual, partnership, or any other entity that provides one or more of goods, services, and consultations to individuals such as customers (e.g., an automobile company). In some embodiments, the calibration system 408 may be controlled by a third party on behalf of another business, corporation, individual, partnership. The calibration system 408 may include one or more servers and computer systems for performing one or more functions associated with products and/or services that the organization provides. Vehicles, such as vehicles 401a, 401b, 401c may be configured to complete a calibration phase. The calibration phase may include gathering vehicle data over a period of time to build the master database of component behavior (e.g., typical component ranges at different mileages, etc.). The health monitoring and intervention system 320 may upload and download vehicle data to and from calibration system 408. This data may be combined and aggregated with data of other vehicles by training system 420. Training system 420 may create training data from the aggregated data that may be transmitted to the health monitoring and intervention systems 320 of individual vehicles. Training system 420 may comprise one or more machine learning models. The training data may be used to enhance the performance of the health monitoring and intervention system 320. By transmitting the training data to the health monitoring and intervention systems 320 of individual vehicles, the systems may determine and generate more accurate optimal ranges or thresholds, and may better modify operating modes and operating parameters.

Web server 410 may include a computer system configured to generate and provide one or more websites accessible to customers, as well as any other individuals involved in access calibration system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402 or vehicles 401a, 401b, 401c. For example, web server 410 may host a financial service provider website that a user device may access by providing an attempted login that are authenticated by the training system 420. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the calibration system 408 to interact with one another and to connect to the network 406 for interacting with components in the system 400 environment. In some embodiments, the local network 412 may include an interface for communicating with or linking to the network 406. In other embodiments, certain components of the calibration system 408 may communicate via the network 406, without a separate local network 406.

The calibration system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access calibration system 408 using the cloud computing environment. User device 402 may be able to access calibration system 408 using specialized software. The cloud computing environment may eliminate the need to install specialized software on user device 402.

In accordance with certain example implementations of the disclosed technology, the calibration system 408 may include one or more computer systems configured to compile data from a plurality of sources (e.g., data provided from vehicles 401a, 401b, 401c or the health monitoring and intervention system 320 of each of those vehicles respectively), web server 410, and/or the database 416. The training system 420 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include location data, velocity data, position data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

Although the preceding description describes various functions of a web server 410, a training system 420, a database 416, in some embodiments, some or all of these functions may be carried out by a single computing device.

FIG. 5 is a block diagram of an example vehicle system 500 that may provide data to and receive instructions from health monitoring and intervention system 320. The components and arrangements shown in FIG. 5 are not intended to limit the disclosed embodiments as the components used to implement the disclosed processes and features may vary. As shown, vehicle system 500 may include a health monitoring and intervention system 320, one or more body control modules 510, one or more compressor control modules 520, one or more pump control modules 530, one or more climate control modules 540, one or more drive unit control modules 550, one or more driver input controls 560, and one or more communications interfaces 570 connected via a vehicle network 506.

Health monitoring and intervention system 320 may receive input data from or issue instructions to each of the other modules in vehicle system 500 via the vehicle network 506. The vehicle network 506 may be a can-bus, ethernet, or other vehicle network. The vehicle network may be similar to network 406 of FIG. 4. The vehicle network may be connected to a communications interface 570, which may include a wireless connection, such as a WiFi connection or cellular connection for interacting with a mobile device of a user or calibration system 408. In some embodiments, health monitoring and intervention system 320 may transmit one or more thresholds or ranges to one or more modules or systems. The one or more modules or systems may modify the operating mode of individual components and transmit modifications to the health monitoring and intervention system 320.

Health monitoring and intervention system 320 may interact with a variety of vehicle systems via associated modules via the vehicle network 506 within the vehicle system 500. The body control module 510 may control lighting 511 or other features of the vehicle body, such as seat controls, window controls, and door locks. The compressor control module 520 may control one or more compressors 521. The pump control module 530 may control one or more oil pumps 531 for one or more drive units or one or more coolant pumps 532 for cooling the battery pack and/or drive units. The climate control module 540 may control the cabin HVAC 541, seat heaters and/or seat coolers 542, and the cabin fan 543. The drive unit control module 550 may control one or more drive units 551. Health monitoring and intervention system 320 may receive inputs from driver input control 560, which may include a multimedia system. Driver input control 560 may monitor throttle inputs 561, navigation input 562, and climate control inputs 563, among other inputs.

Although the preceding description describes various functions of a vehicle system 500 separated into different components and modules, in some embodiments, some or all of these functions may be carried out by a single computing device.

### EXAMPLE USE CASES

The following example use cases describe examples of a typical flow pattern using the above predictive system. This section is intended solely for explanatory purposes and not in limitation.

### Example 1—Powertrain Compressor

In one example, a vehicle monitors a powertrain compressor and transmits data regarding the powertrain compressor over time to the health monitoring and intervention system 320 (e.g., at block 102), which stores the data (e.g., at block 104). The powertrain compressor in normal use draws between 5 A and 25 A of current. The fuse limit of the powertrain compressor is 40 A. After the data has been gathered, the health monitoring and intervention system 320 determines an optimal range for the current of the powertrain compressor is between 5 A and 22 A (e.g., at block 106). On the next drive, which is on a hot day with a temperature of 92 degrees Fahrenheit, the powertrain compressor quickly ramps up to full power and draws 28 A of current, which is received at health monitoring and intervention system 320 (e.g., at block 108). The health monitoring and intervention system 320 determines that the 28 A of current is outside the optimal range of 5 A to 22 A because 28 A is larger than the upper bound of the optimal range (e.g., at block 110). The health monitoring and intervention system 320 then adjusts the operating mode of the powertrain compressor such that on days where the temperature is greater than 80 degrees Fahrenheit, the start-up process of the powertrain compressor begins more slowly (over 10 seconds instead of the typical 5 seconds) (e.g., at block 112). During the next week, there is day where the temperature is 87 degrees Fahrenheit, and the powertrain compressor is started more slowly and draws 20 A of current (e.g., at block 108). The health monitoring and intervention system 320 determines that the powertrain compressor is operating with the optimal range of 5 A to 22 A because 20 A is less than 22 A (e.g., at block 110). Therefore, the health monitoring and intervention system 320 maintains the settings for the powertrain compressor to start-up over 10 seconds when the temperature is greater than 80 degrees Fahrenheit (e.g., block 120). By preventing the powertrain compressor from drawing excess current, the powertrain compressor will have less degradation over time and will last longer. The driver is unaware of any change to the operation of the vehicle.

### Example 2—Drive Unit Oil Pump

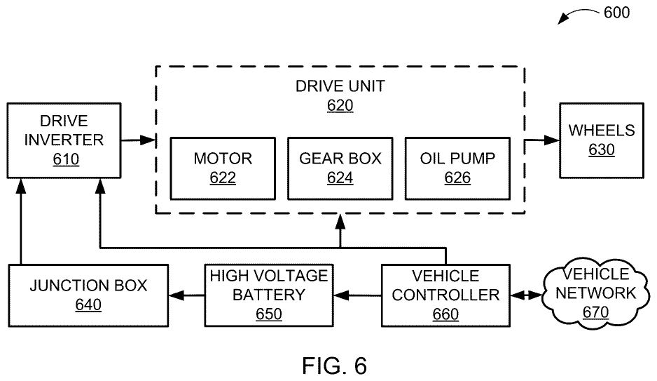

In electric and hybrid vehicles, an electric motor may be the primary motor used for propulsion. FIG. 6 illustrates an example electric propulsion system 600. The electric motor 622 may be part of a drive unit (DU) 620 which combines the electric motor 622 with a gear box 624 and oil pump 626, providing rotational motion to the wheels 630. The electric motor may be powered by an electric vehicle high-voltage battery 650 via a junction box 640 with a drive inverter (DI) 610 providing control via inputs provided by a vehicle controller or vehicle control unit (VCU) 660. The vehicle controller may connect to other parts of the vehicle via the vehicle network 670, which may be similar to vehicle network 506. In the DU 620, the oil pump 626 may be used to cool the gearbox 624, motor 622 (e.g., the stator-rotor assembly), geartrain (gears, shafts, bearings), and differential. In some examples, the oil pump 626 may be controlled directly by the DI 610, but can also be controlled by the VCU 660, which may be able to control non-high voltage loads (e.g., 5V, 12V, 24V, and 48V). Accordingly, in an example electric vehicle, a predictive system (e.g., health monitoring and intervention system 320), which may be separate or integrated into the VCU 660 or other modules, may react to detected degraded oil pump performance and make corrections to enhance performance. If the oil pump has degraded performance, there may be reduced output flow, affecting gearbox lubrication, part longevity, gearbox cooling, stator/rotor cooling, causing increased wear and tear, and overall degraded vehicle performance.

In this example, the system continuously monitors pump flow output via a CAN-bus, LIN-bus, Ethernet, or analog channels (or over a vehicle network e.g., vehicle network 670). Input data from sensors may be correlated to indicate pump flow (e.g., a received or indicated voltage, amperage, or resistance at the VCU may correlate to pump flow in liters per minute or gallons per minute). Accordingly, the system may store or derive an expected performance of the pump (e.g., an expected pump flow in liters per minute) for a specific requested output (e.g., 50% overall power). The system may track the actual performance of the pump (e.g., an actual pump flow in liters per minute) for a specific requested output over time. The system may generate a trendline related to performance over time (e.g., for a particular output). Accordingly, when graphed, the actual performance over time may be expected to trend linearly and horizontally (e.g., a trendline corresponding to flow rate performance may have a near zero slope for a specific requested output). If the pump output begins to degrade, inflection points may occur where the trendline begins to slope negatively, indicating that pump output in slowing for a specific requested output. Accordingly, the system may determine the difference between the pump flow and a standard performance of the pump by comparing the trendline with an expected performance. Accordingly, the predictive system may calculate degradation as a percentage and may alert other vehicle systems (e.g., the VCU) of the anomaly. The system may begin alerting other vehicle systems with degradations as small as less than 1%, 1-2%, 2-3%, or more. As such, the system may be able to detect degradation far before it would be perceived by the user.

The predictive system may also calculate expected degradation, which may be related to usage models (e.g., expected degradation after time, mileage, or duty cycles). The predictive system may compare the trendline of the actual performance over time to the expected performance given the expected degradation. If the calculated degradation is below the expected performance given the expected degradation, the predictive system may begin alerting other vehicle systems.

The predictive system may send instructions or signals to other vehicle systems to minimize performance loss, reduce downtime, increase component longevity, and minimize the chance of catastrophic utility loss. Accordingly, the instructions may be grouped into a series of different levels. The predictive system may send instructions, monitor the vehicle performance (or pump performance), and make modifications to the instructions to further enhance performance if necessary.

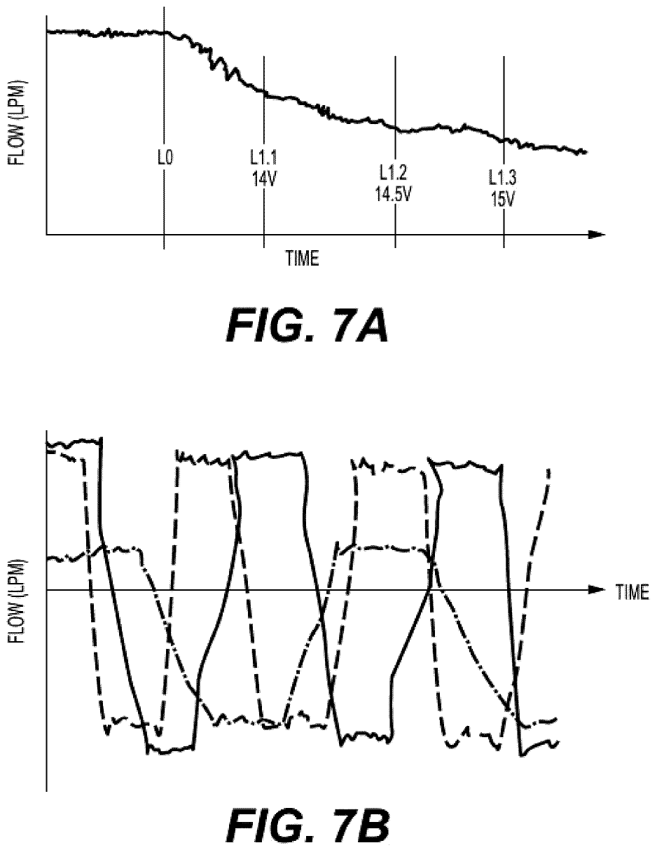

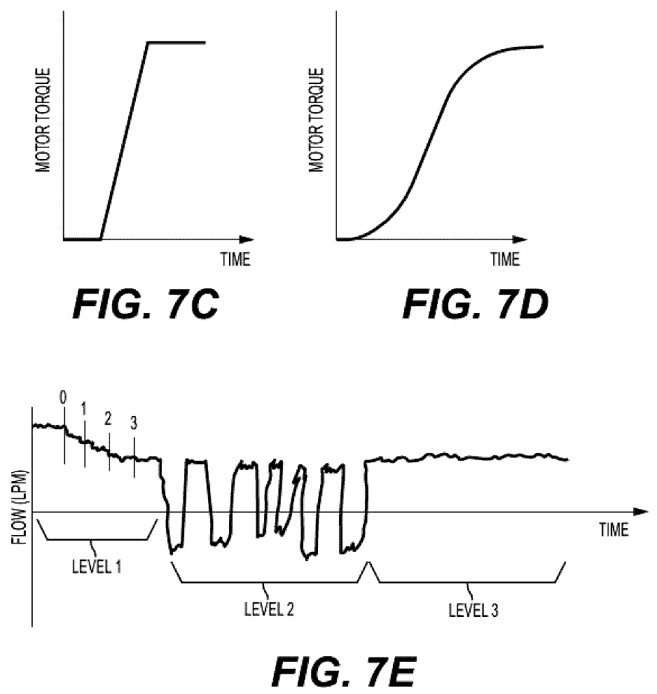

At a first intervention level, as shown in FIG. 7A, the predictive system may increase the pump performance by driving the pump incrementally faster to overcome the lesser flow rate. The pump speed may be proportional to a driving voltage. Accordingly, the predictive system may provide instructions to the VCU, DI, and/or other parts to increase the driving voltage (or power) of the pump. There may be one or more sublevels within the first level. As such, for a typical voltage of 13.5V for a specific requested output (L0), the predictive system may increase the pump to 14V at a first sublevel (L1.1) if degradation is detected. The predictive system may monitor whether the increased voltage reduces the degradation and returns the flow rate to a standard level. If the increased voltage at the first sublevel is ineffective at correcting the degradation, the predictive system may increase the pump to 14.5V at a second sublevel (L1.2) and remeasure the flow rate. If this is still ineffective, the predictive system may increase the pump to 15V at a third sublevel (L1.3) and remeasure the flow rate. If any of the sublevels return the pump to a standard operating status, the predictive system may continue to monitor the operation and continue to provide instructions to maintain the pump's operation according to the desired sublevel.

In the event that the instructions at the first intervention level fail to overcome the pump degradation, the predictive system may resort to a second intervention level, which may include additional instructions. The second intervention level, as shown in FIG. 7B, may include reversing the flow of the pump. Reversing the pump flow may clear debris that have been caught in the oil pump filter or in other portions of the lubrication circuit. In this case, the DI may utilize bi-directional drivers to swap the logic to drive the motor of the pump in reverse. Several different flow and pulse frequencies may be used to purge the oil pump filter (e.g., low frequency switching, high frequency switching, switching between lower voltages). Accordingly, the second intervention level may include both high and low frequency reversing actions, as shown by the different lines in FIG. 7B. These may vary in ramp-rates, pump flow speed, and duration. The predictive system may continue to monitor the operation of the pump after reverse flow is attempted to determine whether standard operation has resumed. The second level interventions may be completed at times where the change in operation would be unknown to the user (e.g., when the vehicle is not moving, at idle, or moving slowly).

Throughout the first two intervention levels, the predictive system may maintain the torque output of the electric motor, as shown in FIG. 7C. In the event that the instructions at the second intervention level fail to overcome the pump degradation, the predictive system may resort to instructions associated with a third intervention level. The third intervention level, as shown in FIG. 7D, may include adjustments to the torque ramp rate of the electric motor (e.g., slowing the acceleration of the motor speed or smoothing sharp changes in motor speed). By adjusting the torque ramp rate of the motor, less heat may be introduced, lessening the dependence on the oil pump to circulate the oil and remove the heat produced. For example, decreasing the change of torque over time and decreasing the ramp rate reduces gear friction, reducing frictional heating and wear and tear. Accordingly, the torque curve of the electric motor may include increased curvature (as compared to typical operation shown in FIG. 7C). In addition, the operation of the electric motor may change during regeneration or recuperation in a similar manner to reduce wear and tear and to lower fluid temperature. The user may be notified that higher performance modes (e.g., sport or track mode) of the vehicle may not exhibit full performance on a temporary basis. Normal driving of the vehicle may be unchanged and unnoticed by the user. The predictive system may continue to monitor the operation of the pump after the third intervention level controls are attempted to determine whether standard operation has resumed. FIG. 7E shows a graph of the oil pump flow rate during the first three intervention levels, the time at which pump began to show degradation (0), and the first three sublevels of the first intervention level (1, 2, 3).

In the event that the third intervention level instructions fail to overcome the pump degradation, the predictive system may resort to a fourth intervention level. The fourth invention level may include instructions with combinations of the instructions from the prior three levels, and additional functions as shown in Table 1 below:

TABLE 1
Level 4 Operation

| | | Level 2 | Level 3 |
|---|---|---|---|
| | Level 1 | Operation - | Operation - |
| | Operation - | Reversing | Reduce torque |
| Attempt | Increase | and cycling | ramp rate of |
| No. | pump voltage | pump flow | electric motor |
| 1 | ON - Sublevel 1 | | |
| 2 | ON - Sublevel 2 | | |
| 3 | ON - Sublevel 3 | | |
| 4 | ON - Sublevel 1 | ON - Low Frequency | ON |
| 5 | ON - Sublevel 3 | ON - High Frequency | ON |
| 6 | ON - Sublevel 3 | ON - Low and High | ON |
| | | Frequency | |

| | |
|---|---|
| 7 | Repeat Attempts 1-6 three times |
| 8 | (1) Turn oil pump OFF, (2) wait designated time, |
| | (3) Turn oil pump ON and repeat Attempt 7 |

The designated time may be a predetermined set value or may be a value determined by predictive system. The value may be determined by an estimated period of time that the oil pump may be shut down before overheating occurs. In the event that all attempts of the fourth invention level do not return the pump to standard operation, the user may be notified of an impending oil pump issue and may be recommended to take the vehicle in for service. In some embodiments, a machine learning model may be used, as describe above to modify the different levels, the different ranges triggering the different levels, the order of the different levels, the expected performance, the designated time, and/or the user notification.

### Example 3—Pneumatic Air System

Some vehicles may include a pneumatic compressed air system, which may be used to provide a variety of features, such as air suspension, tire inflation, or air braking. Commercial vehicles, such as a Class 8 heavy duty long-haul semi-truck and industry vehicles (e.g., mining vehicles) may rely on these features for operation. Accordingly, internal combustion, electric, and hybrid variants of these vehicles may include a predictive system (e.g., health monitoring and intervention system 320) for use with the compressed air system.

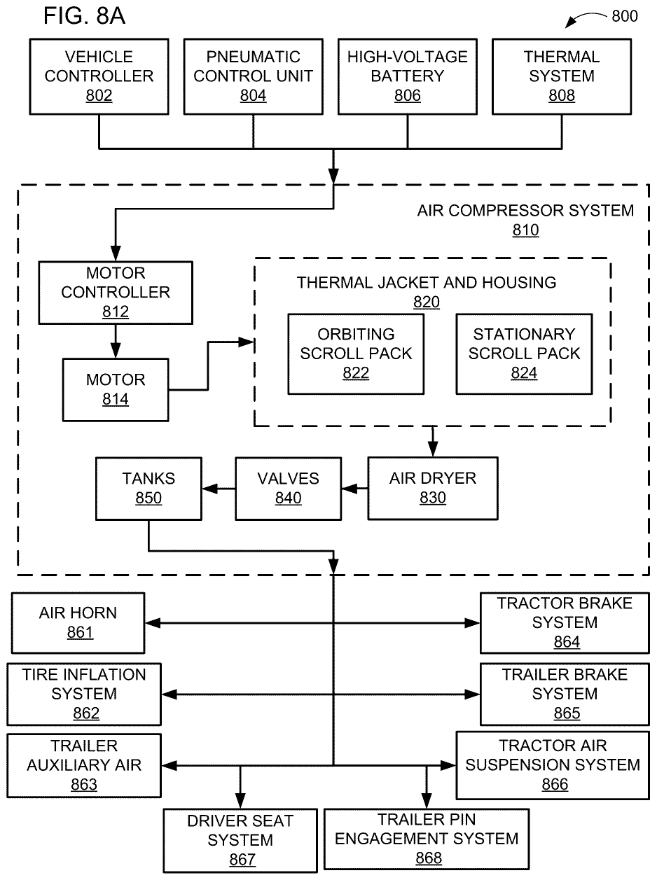

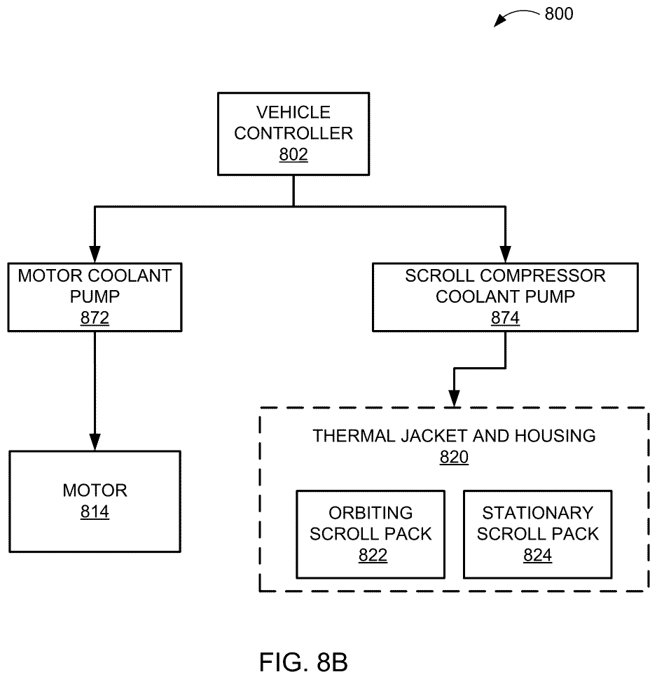

In the aforementioned vehicles, as shown in FIG. 8A, a pneumatic system 800 may include a vehicle controller (VCU) 802, a pneumatic control unit 804, a high-voltage battery 806, and a thermal system 808. The pneumatic system may include an air compressor system (ACS) 810. The ACS may include a scroll air compressor (with an orbiting scroll pack 822 and stationary scroll pack 824 within a thermal jacket and housing 820) powered by an ACS motor 814. The ACS motor may be controlled by a motor controller 812 with signals from a pneumatic control unit 804 or VCU 802, and may be supplied power from the high-voltage battery 806. From the compressor output, compressed air may travel through an air dryer 830, a series of one or more valves 840, and be stored in one or more tanks 850. Multiple loads may be supplied by the ACS 810, such as an air horn 861, tire inflation system 862, trailer auxiliary air system 863, a tractor brake system 864, a trailer brake system 865, a tractor air suspension system 866, a driver seat system 867, and a trailer pin engagement system 868. The pneumatic system 800 may also include a thermal control system, which may also be part of thermal system 808 and/or part of the ACS 810, which monitors and controls temperatures throughout the pneumatic system 800 and air compressor system 810 with data provided by a variety of temperature sensors. The thermal system may be managed by vehicle controller 802 and may include two coolant pumps: a motor coolant pump 872 to supply coolant to the ACS motor 814 and a scroll compressor coolant pump 874 to supply coolant to the scroll compressor (e.g., thermal jacket and housing 820). Because the ACS supplies power to vital functions (e.g., in a Claim 8 semi-truck: the tractor brake system, the trailer brake system, the tire inflation system, and the tractor air suspension system), a failure could be catastrophic and could result in a crash.

The compressed air output temperature is measured by one or more sensors continuously. When the compressed air output is too hot, it indicates a malfunction with the compressor or other portion of the system and must be fixed. Accordingly, in some cases the driver must discontinue driving to rectify the problem. In this example, the predictive system may take preliminary actions to correct the problem while the driver continues traveling. As the predictive system receives output air temperature data, it may determine an average temperature over time. The average temperature may be considered standard when in a specific temperature range, which may be determined by prior or pre-calibrated data, or data from multiple vehicles. In some embodiments, a machine learning model may determine the standard temperature range. Accordingly, the predictive system may determine that the output air temperature suggests an abnormal condition when it increases overtime. When the predictive system determines that the output air temperature is trending upward, and it cannot be explained for other reasons (e.g., high duty cycle, high exterior temperature), the predictive system may determine that taking remedial action is necessary.

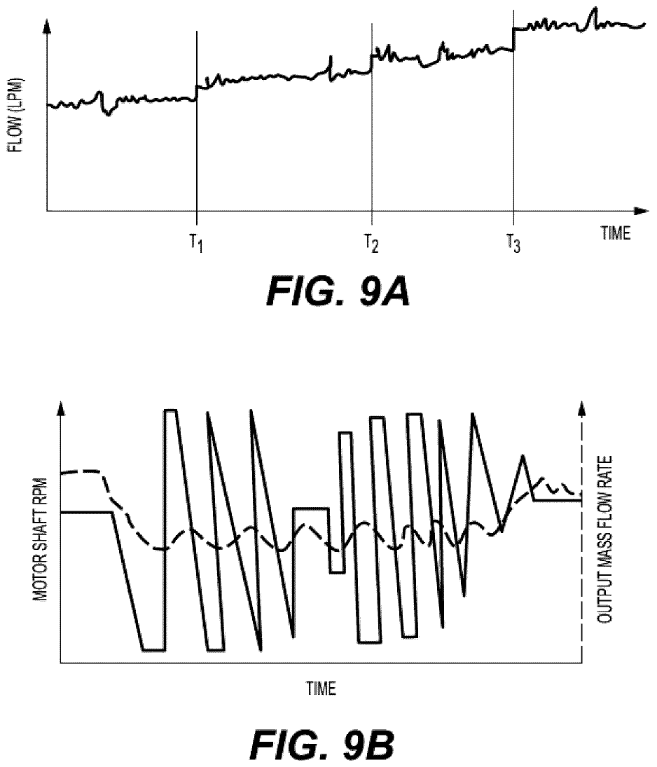

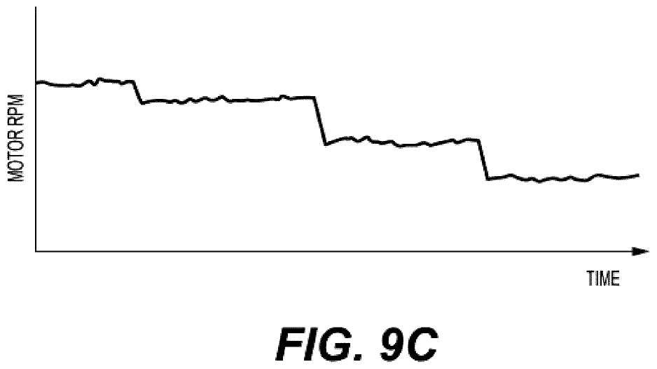

At a first intervention level, the prediction system may attempt to manage heat transfer from the ACS motor to the scroll compressor. Accordingly, the prediction system may transmit instructions to increase the ACS motor coolant pump speed incrementally to remove additional heat introduced by the ACS motor from the system, similar to the graph of flow rate over time as shown in FIG. 9A. The prediction system may have multiple sublevels at the first intervention level (e.g., three sublevels, each higher level increasing the pump speed by 10%, shown at T₁, T₂, and T₃ in FIG. 9A). The prediction system may monitor the temperature to determine whether increasing the coolant pump speed has caused the increase in temperature to abate. If the temperature has returned to a normal level, the prediction system may allow the ACS motor coolant pump to continue to operate at the higher level. If the temperature continues to increase, the prediction system may continue to other intervention levels.

At a second intervention level, the prediction system may attempt to manage heat generated by the scroll compressor. Accordingly, the prediction system may transmit instructions to increase the scroll compressor coolant pump speed incrementally to remove additional heat introduced by the scroll compressor, similar to the graph of flow rate over time as shown in FIG. 9A. The prediction system may have multiple sublevels at the first intervention level (e.g., three sublevels, each higher level increasing the pump speed by 10%%, shown at T₁, T₂, and T₃ in FIG. 9A). The prediction system may monitor the temperature to determine whether increasing the coolant pump speed has caused the increase in temperature to abate. If the temperature has returned to a normal level, the prediction system may allow the scroll compressor coolant pump to continue to operate at the higher level. The prediction system may determine an optimized approach by using a combination of sublevels of the first intervention level and the second intervention level. For example, the prediction system may determine that the first sublevel of the first level and the second sublevel of the second level in combination provide the most efficient control of the increased temperature (e.g., controlling the temperature while minimizing power usage of the two coolant pumps). If the temperature continues to increase, the prediction system may continue to other intervention levels.

At a third intervention level, the prediction system may attempt to use a strategy to clear foreign object debris or clogs from the compressor or other parts of the ACS. Accordingly, the prediction system may transmit instructions to cause the ACS motor and/or scroll compressor to pulse at low and high speeds (RPMs) with abrupt speed changes (e.g., from full flow to zero flow and back to full flow), as shown in FIG. 9B (showing the motor RPM pulsing and the associated changes in output mass flow rate from the compressor). By varying the output in this manner, the prediction system may be able to dislodge the clogging debris, thereby overcoming flow limitations causing the increase of temperature. Accordingly, if the prediction system is able to reduce temperatures, then operation of the ACS may be returned to normal (or a variation of the first and second intervention levels). If the temperature continues to increase, the prediction system may continue to other intervention levels.

At a fourth intervention level, the prediction system may attempt to use a strategy to clean the ACS. The ACS may include an air dryer, which may include filters and desiccants to clean and dry the air within the ACS, as controlled by a purge valve. Accordingly, the prediction system may transmit instructions to cause the purge valve to open more frequently than normal. By increasing the purge valve frequency to more than the normal frequency (e.g., three to four times the typical frequency used with a typically operating system), the ACS may be able to dissolve any contaminants or salts blocking the flow within the system (e.g., debris creating back pressure and loading the compressor, causing an increase in heat). Accordingly, if the increase in purge valve operation reduces temperatures, then operation of the ACS may be returned to normal (or a variation of the prior intervention levels). If the temperature continues to increase, the prediction system may continue to other intervention levels.

At a fifth intervention level, if none of the prior intervention levels have resulted in reducing the temperature, the prediction system may attempt to use a strategy to reduce load on the ACS. Accordingly, the prediction system may transmit instructions to reduce non-critical loads to lower demand on the ACS (e.g., if equipped, reduce pressure to the driver air-ride seating system). The prediction system may reduce motor and compressor RPM incrementally, as shown in FIG. 9C. For example, the prediction system may transmit instructions to reduce the motor RPM by 5% and monitor the temperature. If the temperature does not decline or stabilize, the prediction system may reduce the RPM by a further 10% and monitor the temperature. If the temperature does not decline or stabilize, the prediction system may reduce the RPM by a further 10% and monitor the temperature. The prediction system may reduce the ACS RPM as necessary while still maintaining adequate performance of vital components (e.g., air brakes). At any point during the fifth intervention level, the prediction system may send instructions to notify the driver that the ACS is operating outside the optimal range, earlier intervention methods have failed, and/or service is advised at the next available opportunity. The prediction system may notify fleet management that the vehicle requires the ACS system to be reviewed at the next scheduled service. By using the above predictive system, issues within the ACS system can be discovered and corrected for without requiring the vehicle to make an emergency stop, minimalizing operational disturbance. One or more machine learning models may be used to make the determinations of the prediction system, and may revise the interventional levels (e.g., the order) in order to enhance system efficiency or safety. When serviced, vehicle diagnostics may reveal the intervention level and/or remedial actions performed by the predictive system to service technicians, so they may review and decide if further service is required.

In some examples, disclosed systems or methods may involve one or more of the following clauses:

Clause 1: A health monitoring system for preventing degradation of components in a vehicle comprising: one or more processors; a memory in communication with the one or more processors and storing instructions that, when executed by the one or more processors, are configured to cause the system to: receive first input data associated with a first vehicle component, the first input data comprising one or more first values for indicating potential degradation of the first vehicle component; determine, using a first machine learning model, one or more optimal ranges for the first vehicle component based on the first input data; receive second input data associated with the first vehicle component; determine whether the first vehicle component is operating outside a first optimal range of the one or more optimal ranges based on the second input data; and responsive to determining that the first vehicle component is operating outside the first optimal range, change from a standard operating mode to a first alternate operating mode, the first alternate operating mode for reducing degradation of the first vehicle component by performing one or more first actions prior to a failure of the first vehicle component.

Clause 2: The health monitoring system of clause 1, wherein: the memory stores further instructions that, when executed by the one or more processors, are further configured to cause the system to store the first input data associated with the first vehicle component for a first predetermined time period; and the one or more first actions further comprise: reducing a maximum requestable power of the first vehicle component; increasing coolant flow to the first vehicle component; altering start-up and shut-down commands of the first vehicle component; or combinations thereof, and the second input data comprises one or more second values corresponding to the one or more first values.

Clause 3: The health monitoring system of clause 1, wherein: operating outside the first optimal range is above a normal operating envelope of the first vehicle component and below a fuse threshold, and the first vehicle component is a compressor, a drive unit, a module, a cooling fan, or combinations thereof.

Clause 4: The health monitoring system of clause 1, wherein the memory stores further instructions that, when executed by the one or more processors, are further configured to cause the system to: receive third input data associated with the first vehicle component while the vehicle is operating in the first alternate operating mode; determine whether the first vehicle component is operating outside the first optimal range while the vehicle is operating in the first alternate operating mode based on the third input data; responsive to determining that the first vehicle component is not operating outside the first optimal range while the vehicle is operating in the first alternate operating mode, maintain the first alternate operating mode; and responsive to determining that the first vehicle component is operating outside the first optimal range while the vehicle is operating in the first alternate operating mode: change from the first alternate operating mode to a second alternate operating mode, the second alternate operating mode for reducing degradation of the first vehicle component by performing one or more second actions prior to a failure of the first vehicle component.

Clause 5: The health monitoring system of clause 4, wherein: the one or more second actions are different than the one or more first actions.

Clause 6: The health monitoring system of clause 4, wherein changing from the first alternate operating mode to the second alternate operating mode further comprises: transmitting, to a user, a notification indicating that the first vehicle component is operating outside the first optimal range prior to an observed loss of function.

Clause 7: The health monitoring system of clause 4, wherein the memory stores further instructions that, when executed by the one or more processors, are further configured to cause the system to: determine whether the first vehicle component is operating outside a second optimal range of the one or more optimal ranges while the vehicle is operating in the first alternate operating mode, and wherein: the second optimal range is different from the first optimal range.

Clause 8: A health monitoring system for preventing degradation of components in a vehicle comprising: one or more processors; a memory in communication with the one or more processors and storing instructions that, when executed by the one or more processors, are configured to cause the system to: receive first input data associated with a first vehicle component; determine, using a first machine learning model, a first optimal range for the first vehicle component based on the first input data; receive second input data associated with the first vehicle component; determine whether the first vehicle component is operating outside the first optimal range based on the second input data and without an observed loss of functionality; and responsive to determining the first vehicle component is operating outside the first optimal range based on the second input data, modify one or more first operating parameters associated with the first vehicle component.

Clause 9: The health monitoring system of clause 8, wherein the memory stores further instructions that, when executed by the one or more processors, are further configured to cause the system to: receive third input data associated with the first vehicle component; determine whether the first vehicle component is operating outside the first optimal range based on the third input data; and responsive to determining that the first vehicle component is operating outside the first optimal range based on the third input data, modify one or more second operating parameters associated with the first vehicle component.

Clause 10: The health monitoring system of clause 9, wherein: the one or more second operating parameters are different from the one or more first operating parameters, and the memory stores further instructions that, when executed by the one or more processors, are further configured to cause the system to: responsive to determining that the first vehicle component is operating within the first optimal range based on the third input data, maintain the modified one or more first operating parameters.

Clause 11: The health monitoring system of clause 10, wherein the memory stores further instructions that, when executed by the one or more processors, are further configured to cause the system to: receive fourth input data associated with the first vehicle component; determine whether the first vehicle component is operating outside the first optimal range based on the fourth input data; and responsive to determining that the first vehicle component is operating outside the first optimal range based on the fourth input data: transmit an alert to a user to schedule service associated with the first vehicle component.

Clause 12: The health monitoring system of clause 11, wherein the memory stores further instructions that, when executed by the one or more processors, are further configured to cause the system to: determine, using the first machine learning model, a second optimal range for the first vehicle component; determine whether the first vehicle component is operating outside the second optimal range based on the fourth input data; and responsive to determining that the first vehicle component is operating outside the second optimal range: modify, using a second machine learning model, one or more third operating parameters associated with the first vehicle component.

Clause 13: A health monitoring system for preventing degradation of components in a vehicle comprising: one or more processors; a memory in communication with the one or more processors and storing instructions that, when executed by the one or more processors, are configured to cause the system to: receive first input data associated with a first vehicle component while operating the vehicle in a first mode; determine, using a first machine learning model, a first threshold associated with the first vehicle component based on the first input data; receive second input data associated with the first vehicle component; determine whether the first vehicle component is operating outside the first threshold based on the second input data; and responsive to determining that the first vehicle component is operating outside the first threshold, operate the vehicle in a second mode, wherein the second mode reduces degradation of the first vehicle component.

Clause 14: The health monitoring system of clause 13, wherein: the first input data is historical data comprises operational parameters of the first vehicle component in the vehicle during a first predetermined time period, the first predetermined time period is up to 90 days, and the memory stores further instructions that, when executed by the one or more processors, are further configured to cause the system to: store the first input data associated with the first vehicle component for the first predetermined time period, and track the first input data received from the first vehicle component over time.

Clause 15: The health monitoring system of clause 13, wherein: the first vehicle component is fully operational, the first threshold is associated with power consumption, heat production, or combinations thereof, and the first vehicle component operating outside the first threshold indicates degradation of the first vehicle component.

Clause 16: The health monitoring system of clause 15, wherein: the first machine learning model is trained using data of other vehicles comprising the first vehicle component.

Clause 17: The health monitoring system of clause 13, wherein: the first vehicle component is one or more batteries, one or more motors, one or more pumps, one or more electronic control modules, or combinations thereof.

Clause 18: The health monitoring system of clause 13, wherein: the first mode is a conventional operating mode, the second mode is a conventional operating mode with altered vehicle functionality, and the altered vehicle functionality is minimally noticeable to a user.

Clause 19: The health monitoring system of clause 13, wherein the second mode reduces degradation of the first vehicle component by: increasing coolant flow to the first vehicle component to compensate for additional heat production.

Clause 20: The health monitoring system of clause 13, wherein the second mode reduces degradation of the first vehicle component by: reducing a maximum requestable performance of the first vehicle component; and reconfiguring a start-up cycle and a shut-down cycle of the first vehicle component to generate less heat.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A health monitoring system for preventing degradation of components in a vehicle comprising:
one or more processors;
a memory in communication with the one or more processors and storing instructions that, when executed by the one or more processors, are configured to cause the system to:
receive first input data associated with a first vehicle component, the first input data comprising one or more first values for indicating potential degradation of the first vehicle component;
determine, using a first machine learning model, one or more optimal ranges for the first vehicle component based on the first input data;
receive second input data associated with the first vehicle component;
determine whether the first vehicle component is operating outside a first optimal range of the one or more optimal ranges based on the second input data; and
responsive to determining that the first vehicle component is operating outside the first optimal range, change from a standard operating mode to a first alternate operating mode, the first alternate operating mode for reducing degradation of the first vehicle component by performing one or more first actions prior to a failure of the first vehicle component.

2. The health monitoring system of claim 1, wherein:
the memory stores further instructions that, when executed by the one or more processors, are further configured to cause the system to store the first input data associated with the first vehicle component for a first predetermined time period; and
the one or more first actions further comprise:
reducing a maximum requestable power of the first vehicle component;
increasing coolant flow to the first vehicle component;
altering start-up and shut-down commands of the first vehicle component; or
combinations thereof, and
the second input data comprises one or more second values corresponding to the one or more first values.

3. The health monitoring system of claim 1, wherein:
operating outside the first optimal range is above a normal operating envelope of the first vehicle component and below a fuse threshold, and
the first vehicle component is a compressor, a drive unit, a module, a cooling fan, or combinations thereof.

4. The health monitoring system of claim 1, wherein the memory stores further instructions that, when executed by the one or more processors, are further configured to cause the system to:
receive third input data associated with the first vehicle component while the vehicle is operating in the first alternate operating mode;
determine whether the first vehicle component is operating outside the first optimal range while the vehicle is operating in the first alternate operating mode based on the third input data;
responsive to determining that the first vehicle component is not operating outside the first optimal range while the vehicle is operating in the first alternate operating mode, maintain the first alternate operating mode; and
responsive to determining that the first vehicle component is operating outside the first optimal range while the vehicle is operating in the first alternate operating mode:
change from the first alternate operating mode to a second alternate operating mode, the second alternate operating mode for reducing degradation of the first vehicle component by performing one or more second actions prior to a failure of the first vehicle component.

5. The health monitoring system of claim 4, wherein:
the one or more second actions are different than the one or more first actions.

6. The health monitoring system of claim 4, wherein changing from the first alternate operating mode to the second alternate operating mode further comprises:
transmitting, to a user, a notification indicating that the first vehicle component is operating outside the first optimal range prior to an observed loss of function.

7. The health monitoring system of claim 4, wherein the memory stores further instructions that, when executed by the one or more processors, are further configured to cause the system to:
determine whether the first vehicle component is operating outside a second optimal range of the one or more optimal ranges while the vehicle is operating in the first alternate operating mode, and
wherein:
the second optimal range is different from the first optimal range.

8. A health monitoring system for preventing degradation of components in a vehicle comprising:
one or more processors;
a memory in communication with the one or more processors and storing instructions that, when executed by the one or more processors, are configured to cause the system to:
receive first input data associated with a first vehicle component;
determine, using a first machine learning model, a first optimal range for the first vehicle component based on the first input data;
receive second input data associated with the first vehicle component;
determine whether the first vehicle component is operating outside the first optimal range based on the second input data and without an observed loss of functionality; and
responsive to determining the first vehicle component is operating outside the first optimal range based on the second input data, modify one or more first operating parameters associated with the first vehicle component.

9. The health monitoring system of claim 8, wherein the memory stores further instructions that, when executed by the one or more processors, are further configured to cause the system to:
receive third input data associated with the first vehicle component;
determine whether the first vehicle component is operating outside the first optimal range based on the third input data; and
responsive to determining that the first vehicle component is operating outside the first optimal range based on the third input data, modify one or more second operating parameters associated with the first vehicle component.

10. The health monitoring system of claim 9, wherein:
the one or more second operating parameters are different from the one or more first operating parameters, and
the memory stores further instructions that, when executed by the one or more processors, are further configured to cause the system to:
responsive to determining that the first vehicle component is operating within the first optimal range based on the third input data, maintain the modified one or more first operating parameters.

11. The health monitoring system of claim 10, wherein the memory stores further instructions that, when executed by the one or more processors, are further configured to cause the system to:
receive fourth input data associated with the first vehicle component;
determine whether the first vehicle component is operating outside the first optimal range based on the fourth input data; and
responsive to determining that the first vehicle component is operating outside the first optimal range based on the fourth input data:
transmit an alert to a user to schedule service associated with the first vehicle component.

12. The health monitoring system of claim 11, wherein the memory stores further instructions that, when executed by the one or more processors, are further configured to cause the system to:
determine, using the first machine learning model, a second optimal range for the first vehicle component;
determine whether the first vehicle component is operating outside the second optimal range based on the fourth input data; and
responsive to determining that the first vehicle component is operating outside the second optimal range:
modify, using a second machine learning model, one or more third operating parameters associated with the first vehicle component.

13. A health monitoring system for preventing degradation of components in a vehicle comprising:
one or more processors;
a memory in communication with the one or more processors and storing instructions that, when executed by the one or more processors, are configured to cause the system to:
receive first input data associated with a first vehicle component while operating the vehicle in a first mode;
determine, using a first machine learning model, a first threshold associated with the first vehicle component based on the first input data;
receive second input data associated with the first vehicle component;
determine whether the first vehicle component is operating outside the first threshold based on the second input data; and
responsive to determining that the first vehicle component is operating outside the first threshold, operate the vehicle in a second mode, wherein the second mode reduces degradation of the first vehicle component.

14. The health monitoring system of claim 13, wherein:
the first input data is historical data comprises operational parameters of the first vehicle component in the vehicle during a first predetermined time period,
the first predetermined time period is up to 90 days, and
the memory stores further instructions that, when executed by the one or more processors, are further configured to cause the system to:
store the first input data associated with the first vehicle component for the first predetermined time period, and
track the first input data received from the first vehicle component over time.

15. The health monitoring system of claim 13, wherein:
the first vehicle component is fully operational,
the first threshold is associated with power consumption, heat production, or combinations thereof, and
the first vehicle component operating outside the first threshold indicates degradation of the first vehicle component.

16. The health monitoring system of claim 15, wherein:
the first machine learning model is trained using data of other vehicles comprising the first vehicle component.

17. The health monitoring system of claim 13, wherein:
the first vehicle component is one or more batteries, one or more motors, one or more pumps, one or more electronic control modules, or combinations thereof.

18. The health monitoring system of claim 13, wherein:
the first mode is a conventional operating mode,
the second mode is a conventional operating mode with altered vehicle functionality, and
the altered vehicle functionality is minimally noticeable to a user.

19. The health monitoring system of claim 13, wherein the second mode reduces degradation of the first vehicle component by:
increasing coolant flow to the first vehicle component to compensate for additional heat production.

20. The health monitoring system of claim 13, wherein the second mode reduces degradation of the first vehicle component by:
reducing a maximum requestable performance of the first vehicle component; and
reconfiguring a start-up cycle and a shut-down cycle of the first vehicle component to generate less heat.
